(19) United States
(12) Patent Application Publication
(10) Pub. No.: US 2001/0047329 A1
(43) Pub. Date: Nov. 29, 2001

(54) Electronic exchange apparatus and method

(76) Inventor: David C. Ashby, Los Altos, CA (US)

Correspondence Address: David C. Ashby, 815 Covington Rd., Los Altos, CA, 94024, US

(21) Appl. No.: 09/896,232

(22) Filed: Jun. 29, 2001

Related U.S. Application Data
(63) Continuation-in-part of application No. 09/754,979, filed on Jan. 5, 2001.
(60) Provisional application No. 60/190,824, filed on Mar. 21, 2000.
(60) Provisional application No. 60/180,733, filed on Feb. 7, 2000.
(60) Provisional application No. 60/174,639, filed on Jan. 5, 2000.

(51) Int. Cl. G06F 17/60

(52) U.S. Cl. 705/39

(57) ABSTRACT

An apparatus for facilitating the exchange of services between a buyer and seller includes a server having a memory to store messages posted by buyers and sellers identifying goods and services. The messages are accessible to buyers and sellers to review the messages and to provide responses thereto. The memory stores a message agreed to between the buyer and seller representing a payment plan and deliverable plan. An escrow procedure stores a monetary representation of a deposit by the buyer equal to an amount of money in an escrow account, according to the agreed upon payment plan. The escrow procedure includes a release procedure that is configured such that when the deliverables are delivered to and approved by the buyer, the release procedure releases the amount of money equal to the respective stage of the agreed upon payment plan. In one embodiment, the system compares the specified parameters to prevailing market rates, and provides the prevailing market rates to the buyer. Advantages of the invention include the ability of the service buyer and seller to connect with one another though postings, and to exchange the payment and services according to an agreed upon payment plan with the security of an escrow. Additional advantages include the ability of the service buyer to purchase the needed services at the best available market rate and to have the services delivered within the parameters identified by the buyer.

### RELATED APPLICATIONS

This application is a continuation-in-part of U.S. Ser. No. 09/754,979 filed Jan. 5, 2001 claiming priority to U.S. Prov. No. 60/190,824 filed Mar. 21, 2000, U.S. Prov. No. 60/180,733 filed Feb. 7, 2000 and U.S. Prov. No. 60/174,639 filed Jan. 5, 2000, all incorporated herein by reference.

### FIELD

The invention is related to an electronic exchange method and apparatus. In particular, the invention provides a method and apparatus for matching buyers with sellers and providing attendant support to a transaction. In the exemplary embodiment, a transaction can include service costs, fees, commodities, licensing and other tangibles and intangibles.

### BACKGROUND

The Internet is a technology that has become widely used for communication between people and businesses. Communication over the Internet often provides a mechanism for connecting buyers and sellers of goods and services. Many web sites host message boards or auctions where sellers of goods can post their products and buyers can then review the merchandise postings. Once the buyer has identified a product, the buyer bids for the product. At the close of the auction, the winning buyer pays the seller and the seller ships the product. However, several problems have occurred in the past with sellers misrepresenting the quality of the product and with buyers not following through with their winning bids or sending false payment.

To remedy this problem, some companies have set up escrow services where the escrow service is sent both the payment and the product. Once the payment has cleared, the escrow service forwards the product to the buyer. Once the buyer verifies the quality of the product, the payment is forwarded to the seller. This is similar to escrow that occurs when a house is purchased, where one lump sum payment is made to the seller at the close of escrow.

In the service business, service providers typically take some time to complete their task and require some level of payment along the way. For example, it may take over a month to prepare a patent application and much longer to prepare a computer program. Also, in the conventional service business, buyers and sellers of services are typically located in close geographic proximity to one another because services are typically customized. However, the Internet has the ability to facilitate connections between buyers and sellers of services who may not have an established relationship and/or who may be located at great geographic distance. To these buyers and sellers an escrow service is important, but a lump sum arrangement is not practical to the buyer or seller; the buyer does not want to pay in full before the service is rendered, and the seller does not want to render the service without payment. Consequently, what is needed is a method and apparatus that combines the benefits of Internet communication along with a customized escrow service between the buyer and seller. Ideally, such a technique would provide safety and security to both the seller and buyer.

In other cases, the goods or services are not necessarily personalized and the buyer wants to get the best value for his money. For example, in order for a business or person to link to the Internet, the business must contract with an Internet provider for access and often for hosting e-mail and other communication support. In the case of an e-commerce application, the business must develop a web site, obtain payment processing and manage order fulfillment. The way most people decide on an Internet provider or other services is by reviewing advertisements, reviewing search engine results or talking to friends and associates. This decision is often inefficient and leads to a business relationship that is not optimized for the buyer. That is, the buyer often pays more than a competitive price and/or does not receive the best range of services. What is needed is a technique that improves the efficiency of such a marketplace and provides safety and security to both the seller and buyer.

### SUMMARY

The invention provides an electronic exchange method and apparatus. The invention combines the benefits of Internet communication with an efficient marketplace that is safe and secure for both the seller and buyer. In one aspect, the marketplace provides custom notification of goods and services and provides a custom escrow technology. In another aspect, the marketplace insures that the buyers obtain the services as a market rate.

The invention combines the benefits of Internet communication and connection along with customized service notification and matching based on a plurality of parameters, and a tool for intelligently contracting and carrying out the transaction. An exemplary method of exchanging services between a buyer and seller includes a seller submitting a registration to receive requests from buyers in a least one preference category. A buyer posts a request for quotes (RFQ) message identifying a need for a service in an RFQ category. When the RFQ category matches the seller's preference category, the system notifies the seller of the RFQ message. The seller reviews the RFQ message and responds to the buyer regarding the requested service. The buyer and the seller form a contract for the service including a payment plan and deliverables plan.

In one aspect of the invention, the buyer's registration includes a field to receive the RFQ message in a preferred language. The system converts the RFQ message to the preferred language and then notifies the seller.

In another aspect of the invention, the system aggregates RFQ messages in at least one category to generate an aggregated RFQ message. The system then notifies sellers of the aggregated RFQ message, and obtains a reduced cost for the aggregated services.

In another aspect of the invention, the buyer deposits an amount of money in an escrow account, according to the agreed upon payment plan, and the seller performs the service. When a deliverable is delivered to and approved by the buyer, the seller receives from the escrow account the amount of money equal to the agreed upon payment plan. The payment plan and deliverables plan can include a down payment or advance payment and a plurality of stages.

In yet another aspect of the invention, the deliverables are intangibles such as rights to a property in the form of a lease or license. For example, the invention can be used to escrow periodic rent payments on a building, or to escrow periodic payments on a license agreement such as an intellectual property license agreement. In such an agreement, the deliverable is the right to use the property for the term specified in the agreement, subject to the multi-stage payment plan. In many cases, payments on an intellectual property license agreement are periodic but vary in amount based on the number of units sold. The invention includes a technique for determining the royalty payable based on the terms and conditions of the contract and the payment schedule. The buyer then deposits the payments into the escrow account and the seller withdraws the payment from the escrow account, thereby approving the given stage of the multi-stage payment plan.

An exemplary apparatus for facilitating an exchange between a buyer and seller includes a server having a memory to store messages posted by buyers and sellers identifying goods and services. The server is accessible to buyers and sellers to review the messages and to provide responses to the respective postings. The memory stores a contract agreed to between the buyer and seller representing a multi-stage payment plan and multi-stage deliverables plan. An escrow procedure stores a monetary representation of a deposit by the buyer equal to an amount of money in an escrow account, according to the agreed upon multi-stage payment plan. In a simple arrangement, the multi-stage payment plan includes an advance payment and a final payment. Also, in a simple arrangement, the multi-stage deliverables plan includes an acceptance of the contract terms and the final deliverable. The escrow procedure includes a release procedure such that when the deliverables according to the multi-stage deliverable plan are delivered to and approved by the buyer, the release procedure releases from the escrow account the amount of money equal to the respective stage of the agreed upon multi-stage payment plan.

An automated exemplary embodiment for facilitating the exchange of services between a buyer and seller includes a server having a memory configured to store a plurality of messages posted by buyers identifying a need for services. In this case, the messages include specified parameters regarding the service need. The server is accessible to service sellers to review the messages and to respond to the messages. A processor is coupled to the memory and compares the entered parameters to prevailing market rates and provides the prevailing market rates to the buyer. Also, the system is configured to allow the buyer to modify the parameters and store the parameters for potential execution. In one embodiment, the processor receives a service request from the buyer, compares the stored parameters to those available from at least one service seller, and if the service seller is willing to provide service within the specified parameters, executes the transaction. In another embodiment, the processor receives a service request from the buyer, compares the stored parameters to those available from at least one service seller, if the service seller is not willing to provide service within the specified parameters, the processor compares the stored parameters to those available from at least one excess capacity seller, and if the excess capacity seller is willing to provide service within the specified parameters, executes the transaction. In yet another embodiment, the processor receives a service request from the buyer, aggregates other service requests having similar stored parameters to form bulk parameters, compares the bulk parameters to those available from at least one service seller, and if the service seller is willing to provide service within the specified bulk parameters, executes the transaction. In this context, a service includes any tangible or intangible such as computer network bandwidth, computer processing capacity, licensing fees and revenues, or other tangibles or intangibles.

In another aspect of the invention, the exchange is dynamic and allows the buyer to specify a range over which the buyer is willing to buy the services. The transaction is processed based on the acceptable range; when the price is above the upper range limit, the transaction is not processed until the price falls below the upper range limit. In another aspect of the invention, the range can include a number of parameters such as time, day, price, acceptable sellers and others. This aspect if particularly useful for commodities where the price may vary by date or time, for example, computer network bandwidth or processing capacity may be less expensive at night.

Advantages of the invention include the ability of the service buyer and seller to connect with one another though postings and notifications, and to exchange the payment and services according to an agreed upon payment plan with the security of an escrow. Additional advantages of the invention include the ability of the service buyer to purchase the needed services at the best available market rate and to have the services delivered within the parameters identified by the buyer.

### BRIEF DESCRIPTION OF THE FIGURES

The invention is described below with reference to the following figures, in which:

FIG. 1 depicts a computer server according to an embodiment of the invention;

FIG. 2 depicts a seller registration screen according to an embodiment of the invention;

FIG. 3 depicts a buyer registration screen according to an embodiment of the invention;

FIGS. 4A-C depict a buyer listing, match data and aggregation data according to an embodiment of the invention;

FIG. 5 is a flowchart showing steps for parties to agree to contract terms according to an embodiment of the invention;

FIGS. 6A-B are sample screen displays for a contract term sheet according to an embodiment of the invention;

FIGS. 7A-D are sample screen displays for an escrow term sheet and licensing term sheet according embodiments of the invention;

FIGS. 8A-C depict a buyer listing, match data and aggregation data according to an embodiment of the invention;

FIG. 9 is a flowchart showing steps for adding a buy listing according to an embodiment of the invention; and

FIG. 10 is a flowchart showing steps for fulfilling a service request according to an embodiment of the invention.

### DETAILED DESCRIPTION

The invention is described with reference to exemplary embodiments. Those skilled in the art will recognize that variations can be made to the description while remaining within the bounds of the claims. For example, while the exemplary embodiments describe transactions related to services, the invention is equally applicable to transactions related to goods, costs, fees, commodities, licensing fees and revenues, or other tangibles or intangibles.

A. Architecture

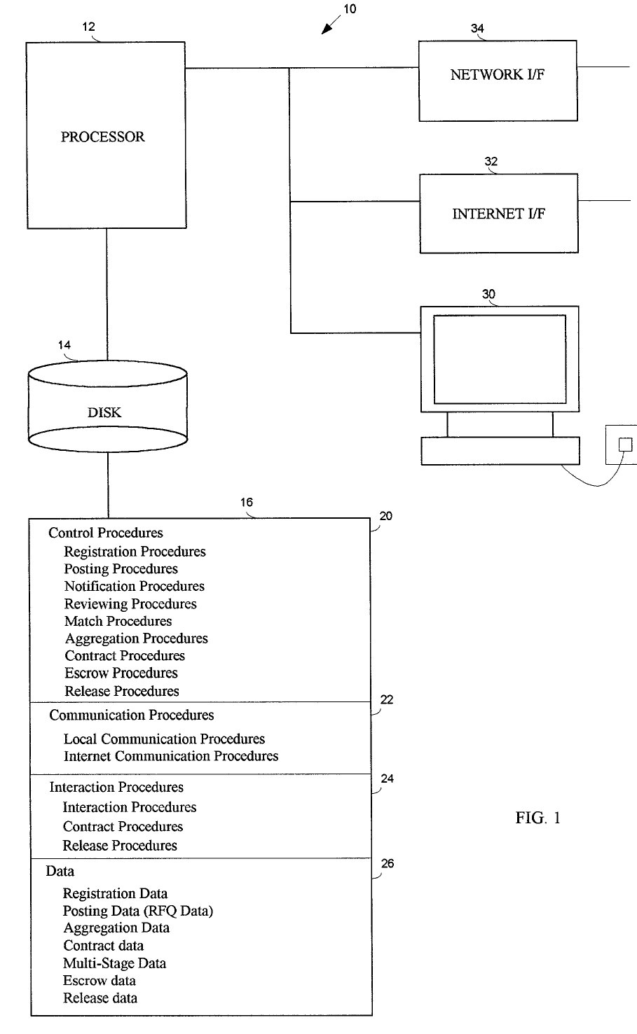

FIG. 1 depicts a computer server 10 according to an embodiment of the invention. The computer includes a processor 12 coupled to a memory 14. The memory contains a storage structure 16 further comprising a plurality of software structures including control procedures 20, communication procedures 22, interaction procedures 24 and data 26. The processor is coupled to a user interface 30, an Internet communication interface 32 and a network interface 34.

The memory's control procedures 20 are program routines that control the operation of the system. For example, the registration procedures manage information related to the registered users of the system and their respective preferences. The posting procedures manage new listings and the notification procedures communicate listings to registered users based on their preferences. The memory 14 is configured to store a plurality of messages posted by buyers and sellers identifying services. The server is accessible to buyers and sellers via the interfaces 32 and 34 in order to review the messages and to provide responses to the respective postings. These procedures are described below in the respective sections.

In one embodiment, the memory 14 is configured to store an installment agreement between the buyer and seller representing a multi-stage payment plan and multi-stage deliverable plan. An escrow procedure is configured to store a monetary representation of a deposit by the buyer equal to an amount of money in an escrow account, according to the agreed upon multistage payment plan. The escrow procedure includes a release procedure such that when the deliverables according to the multi-stage service deliverable plan are delivered to and approved by the buyer, the release procedure releases from the escrow account the amount of money equal to the respective stage of the agreed upon multi-stage payment plan.

In another embodiment, the memory is configured to store market data and allow the automated matching of buyers and sellers according to posted parameters and available parameters. In many instances this is a dynamic pricing model. In one aspect of this embodiment, the memory stores aggregation data allowing a plurality of buyers to aggregate their purchases from a seller.

These embodiments and other aspects of the invention are described in more detail below with reference to the additional figures.

B. Intelligent Notification and Matching

The invention provides an electronic exchange apparatus and method that combines the benefits of Internet communication and connection along with customized service notification and matching based on a plurality of parameters. The invention also includes a tool for intelligently contracting for and carrying out the transaction.

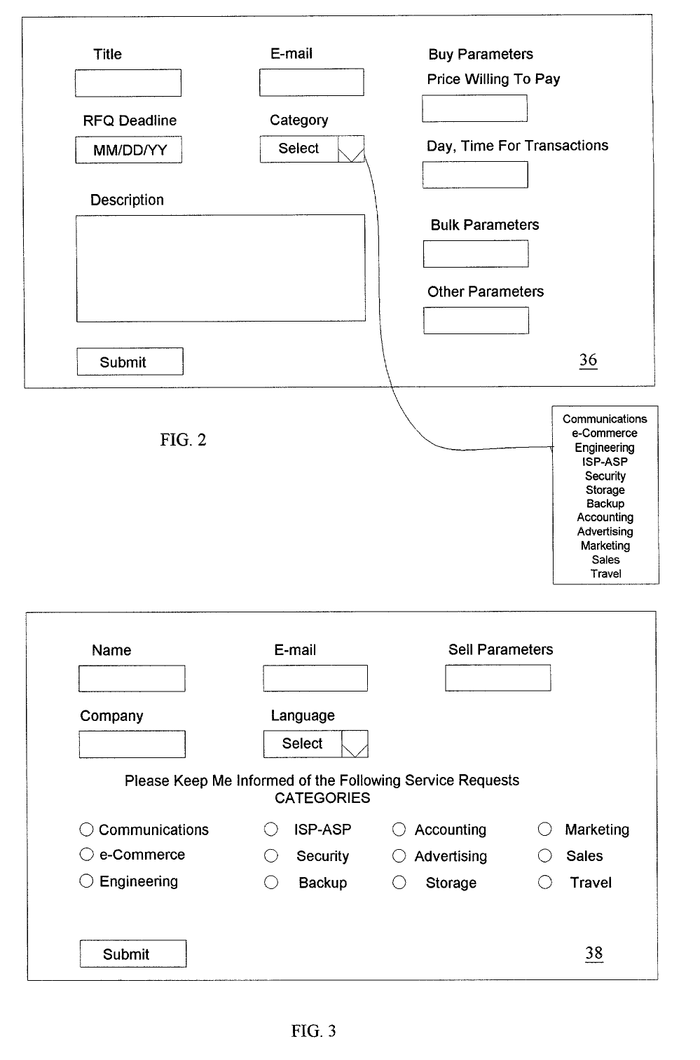

FIG. 2 depicts a seller registration form 36 that includes available parameters on which the buyer is willing to buy the goods or services. The buyer completes the form as a request for quotes (RFQ) message. The registration includes an entry for the listing title as well as any deadline, category and full description. There are entry spaces for a number of related purchase parameters including the price that the buyer is willing to pay for a specified service, the date and time of the transaction, bulk parameters and other parameters. Many of these parameters depend on the specific type of service or transaction. For example, if the service is related to computer network bandwidth, the time parameter may be very important, while if the service is related to excess computer processing capacity, the time parameter may not be important.

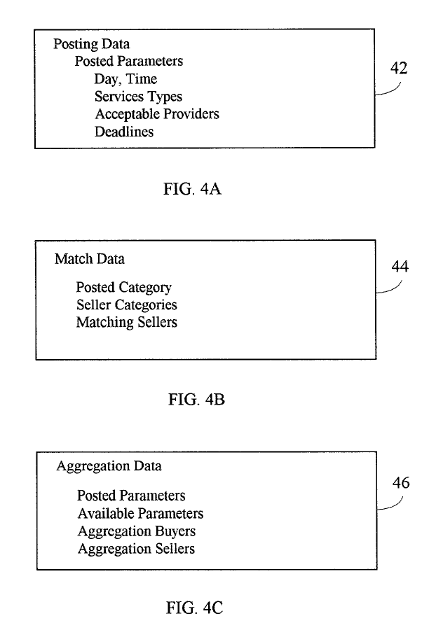

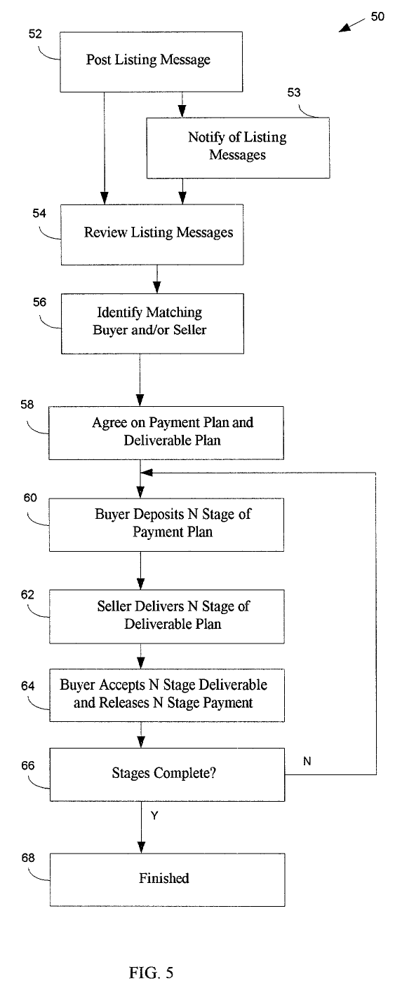

FIG. 3 depicts a buyer registration form 38 that includes available parameters on which the seller is willing to sell the goods or services. The registration includes an entry for the name and company, and category notification attributes that can be associated with a registered user. This allows the computer server 10 to match and notify potential sellers when a buyer posts an RFQ in a specific category. In one aspect of the invention, the buyer can indicate a preference language. The system converts the RFQ message from a posted language to the preference language before notifying the seller of the RFQ message. FIG. 4A depicts a buyer listing 42 showing the posting data, and FIG. 4B depicts match data 44 according to an embodiment of the invention.

In another aspect of the invention, the system aggregates RFQ messages in at least one category to generate an aggregated RFQ message. FIG. 4C shows the aggregation data 46 as stored in the memory 14. The system then notifies service sellers of the aggregated RFQ message. When the service sellers review the aggregated RFQ message, the service sellers bid on providing services to the group of buyers based at least in part on the aggregated RFQ. As a result, the buyers obtain a reduced cost of the aggregated RFQ services. Additional criteria can be applied to aggregate the RFQs such as business identity, geographic location, affinity groups, and other factors.

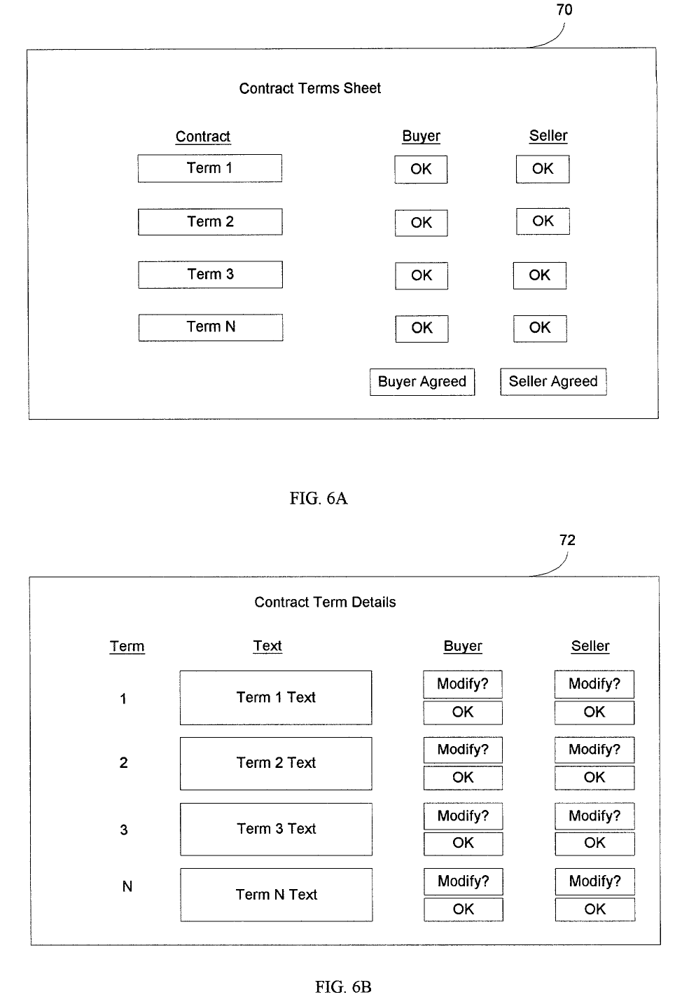

An exemplary method of exchanging services between a buyer and seller includes a service seller submitting a registration to receive requests from service buyers in a least one preference category, as shown in FIG. 3. A service buyer posts a request for quotes (RFQ) message identifying a need for a service in at least one RFQ category, as shown in FIG. 2. This is shown in the FIG. 5 flowchart 50 step 52. When the RFQ category matches the preference category, the method notifies the seller of the RFQ message in step 53. The seller reviews the RFQ message in step 54, shown in FIG. 4A, and responds to the buyer regarding the requested service. Since the buyer may have several offers from sellers, the buyer selects the winning offer in step 56. The buyer and the seller form a contract for the service including a payment plan and deliverable plan in step 58. If the parties wish to handle payment on their own, they may do so. If the parties wish to handle payment through using the escrow agreement technology described herein, the steps continue as described below.

C. Contract Terms and Payment Schedules

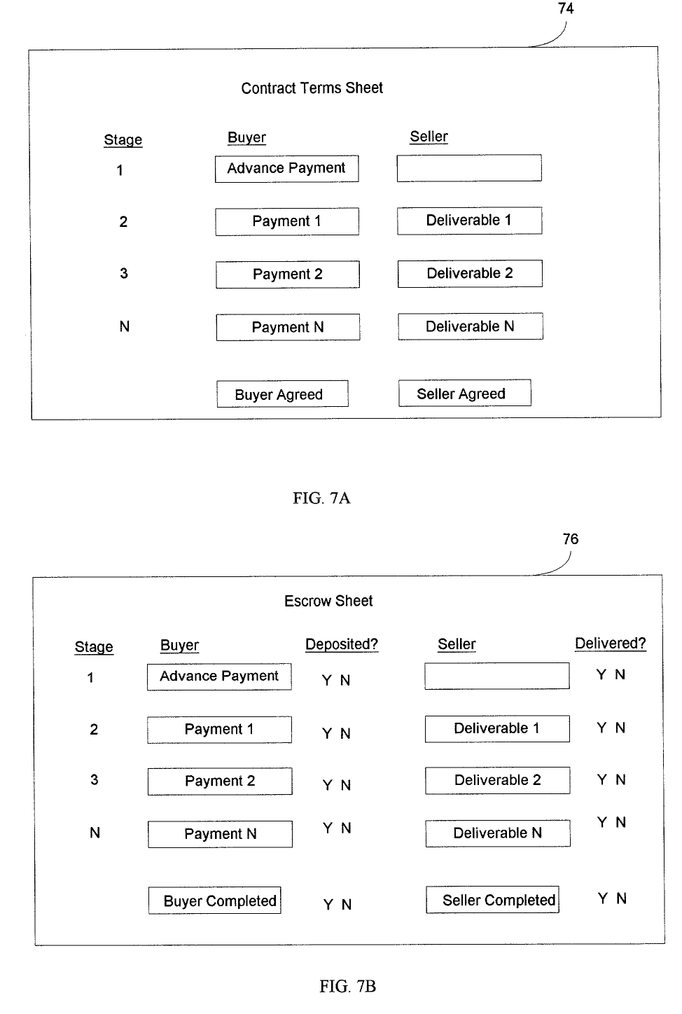

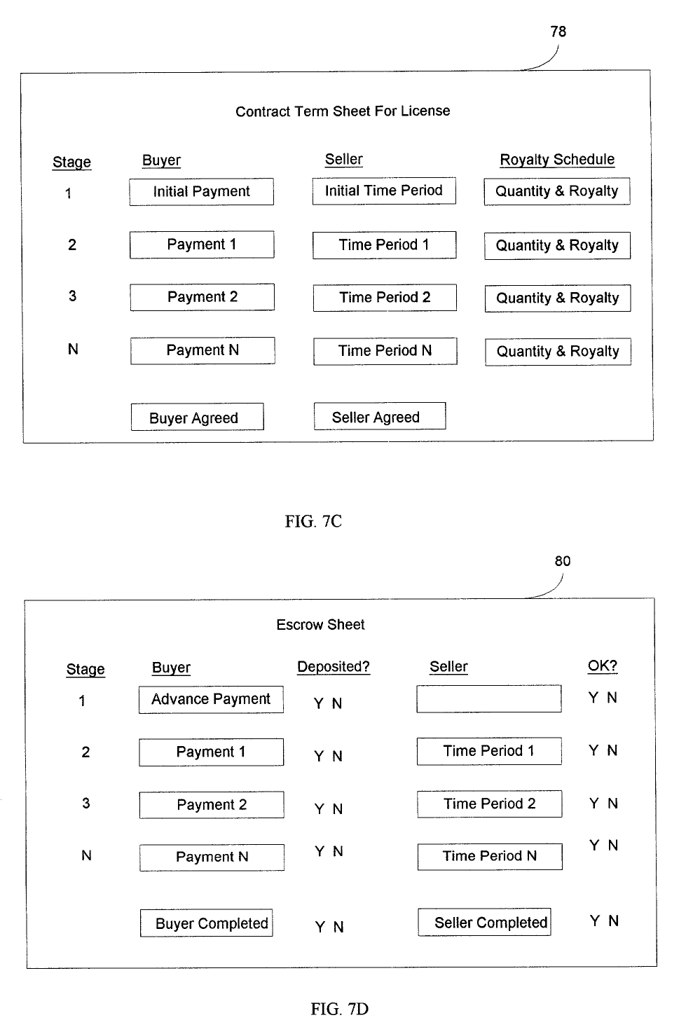

Referring back to FIG. 1, the memory storage structure 16 includes a number of contract procedures, escrow procedures and release procedures. These procedures are used in combination with the other procedures and data in this aspect of the invention. When a buyer and seller have agreed to transact business, the buyer and seller agree upon a contract terms sheet 70 and 74 shown in FIGS. 6A and 7A (described in detail below) that includes a payment plan and a deliverables plan. The plan includes a number of stages 1 to N that represent payments by the buyer and deliverables by the seller. This step is reflected in the FIG. 5 flowchart step 58. The memory 14, in conjunction with a contract procedure, is configured to store contract data and multi-stage data representing the agreement and a multi-stage payment plan and multi-stage service deliverable plan.

FIG. 6A shows a proposed contract terms sheet screen 70 in which the buyer and seller agree on contract terms for the exchange of a service. These terms include, for example, the legal names of the parties, duration of the contract, cost of the goods and services, location of delivery for the deliverables, the payment plan, warranties, confidentiality provisions, choice of dispute resolution, etc. The buyer and seller each have OK buttons displayed on the screen 70 that they set in order to demonstrate their agreement with each of the terms. If the buyer or seller want to review the specific language of each term or suggest a modification to a term, they can do so on screen 72 shown in FIG. 6B. The terms identified on screens 70 and 72 include details to be described below with reference to FIGS. 7A-D. Once the parties have agreed to all the terms, they each signify so in FIG. 6A by clicking on the Buyer Agreed and Seller Agreed buttons.

As part of the contract described above, the parties negotiate terms related to payment and deliverables, as shown in FIG. 7A screen 74, which may be a multi-stage payment plan and multi-stage deliverable plan. This aspect of the invention can include the seller being paid an advance prior to the multi-stage payment plan. FIG. 7B depicts an escrow term sheet 76 that is used by the buyer and seller during the course of the contract to indicate a deposit in escrow, to confirm that the deliverable is acceptable and to secure release of the escrow funds to the seller. In performance of the contract, the buyer deposits an amount of money in an escrow account, according to the agreed upon multi-stage payment plan. The seller performs the stages of the multi-stage performance plan, and when the deliverables are delivered to and approved by the buyer, receives from the escrow account the amount of money equal to the respective stage of the agreed upon multi-stage payment plan.

Referring beck to the FIG. 5 flowchart 50 and FIG. 7B, in step 60 the buyer deposits a payment for a particular stage of the agreement in the escrow account. At this point, the seller would see that the advance payment light is active on the escrow display sheet 76. The seller would know that the funds are in escrow and that he can begin work on the project. In some cases, the buyer would release the advance payment to the seller in advance of work performed. In the exemplary embodiment, the buyer deposits Payment 1 into escrow, which signifies to the seller that the first payment for a deliverable is in escrow. In step 62, the seller then performs work to create the first Deliverable 1 and sends it to the buyer for approval. In step 64, when the buyer accepts and approves the Deliverable 1, money in escrow is released to the seller. Step 66 determines whether the contract is complete. If not, then the buyer deposits Payment 2 into escrow, which signifies to the seller that the second payment for a deliverable is in escrow. The seller then prepares the second deliverable and sends it to the buyer for approval. As the payments are made and the deliverables are approved, the escrow sheet of FIG. 7B screen 76 fills up and the Y N buttons are lit up and approved. This continues until the contract is complete, step 68.

In an aspect of the invention, the deliverables are intangibles such as rights to a property in the form of a lease or license. In the case of a license, the parties may also negotiate a payment schedule and specific time periods as shown in FIG. 7C screen 78, as well as a specific royalty schedule. In this aspect, the invention can be used to escrow periodic rent payments on a building, or to escrow periodic payments on a license agreement such as an intellectual property license agreement. In such an agreement, the deliverable is the right to use the property for the term specified in the agreement, subject to the multi-stage payment plan. For example, the service or deliverable is an action or inaction taken by the seller to refrain from asserting certain rights (e.g. patent rights) against the buyer. In many cases, payments on an intellectual property license agreement are periodic but vary in amount based on the number of units sold. FIG. 7C screen 78 shows a royalty schedule calculator that can determine the royalty payable based on the terms and conditions of the contract and the payment schedule. For example, often royalty rates are graduated, where the royalty rate is lower as the number of units sold increases, and often royalty rates are based at least in part on the number of units sold in a calendar year. The royalty schedule calculator accepts whatever information is necessary to calculate the royalty, for example the number of units sold, and employs the terms agreed upon in the contract, as shown in screen 70, to provide the proper royalty payment amount. This information is available to both parties so the buyer and seller can acknowledge that the correct payment is made. FIG. 7D screen 80 is similar to screen 76, but the deliverables column has time periods therein to show that in the case of a lease or license, the deliverable is the right to use the property for a given time period. Similar to that described above, with reference to FIG. 7B, as shown in FIG. 7D, the buyer deposits the payments into the escrow account and the seller withdraws the payment from the escrow account, thereby approving the given stage of the multi-stage payment plan.

In another aspect of the invention, the system aggregates RFQ messages in at least one category to generate an aggregated RFQ message. The system then notifies service sellers of the aggregated RFQ message, and obtains a reduced cost of the aggregated RFQ services.

In a simple arrangement, the multi-stage payment plan includes an advance payment and a final payment. Also, in a simple arrangement, the multi-stage deliverables plan includes an acceptance of the agreement and the final deliverable. The escrow procedure includes a release procedure that is configured such that when the deliverables according to the multi-stage service deliverables plan are delivered to and approved by the buyer, the release procedure releases from the escrow account the amount of money equal to the respective stage of the agreed upon multistage payment plan.

In one aspect of the invention, the buyer deposits an amount of money in an escrow account, where the amount of money at least meets the first stage of the multi-stage payment plan. The seller performs the first stage of the multi-stage performance plan, and when the first stage deliverable is delivered to and approved by the buyer, receives from the escrow account the amount of money equal to the first stage of the multi-stage payment plan. This aspect of the invention can include the seller being paid an advance prior to the multi-stage payment plan.

In yet another aspect of the invention, the buyer deposits an amount of money in the escrow account, where the amount of money at least meets the first stage and second stage of the multi-stage payment plan. When first stage is complete, the buyer deposits an additional amount of money in the escrow account, where the amount of money at least meets the third stage of the multi-stage payment plan. Likewise, this aspect of the invention can include the seller being paid an advance prior to the multi-stage payment plan.

D. Automated Agreements

An automated exemplary embodiment for facilitating the exchange of services between a buyer and seller includes the server 10 as shown in FIG. 1. In the exemplary embodiment, the messages include parameters regarding a service need. The server is accessible to service sellers to review the messages and to respond to the messages. The processor 12 is configured to compare the entered parameters to prevailing market rates, and to provide the prevailing market rates to the buyer. Also, the system is configured to allow the buyer to modify the parameters and store the parameters for potential execution. In one embodiment, the processor is configured to receive a service request from the buyer, to compare the stored parameters to those available from at least one service seller, and if the service seller is willing to provide service within the specified parameters, to execute the transaction. In another embodiment, the processor is configured to receive a service request from the buyer, to compare the stored parameters to those available from at least one service seller, if the service seller is not willing to provide service within the specified parameters, to compare the stored parameters to those available from at least one excess capacity seller, and if the excess capacity seller is willing to provide service within the specified parameters, to execute the transaction. In yet another embodiment, the processor is configured to receive a service request from the buyer, to aggregate other service requests having similar stored parameters to form bulk parameters, to compare the bulk parameters to those available from at least one service seller; and if the service seller is willing to provide service within the specified bulk parameters, execute the transaction. In this context, a service includes any tangible or intangible such as computer network bandwidth, computer processing capacity, licensing fees and revenues, or other tangibles or intangibles.

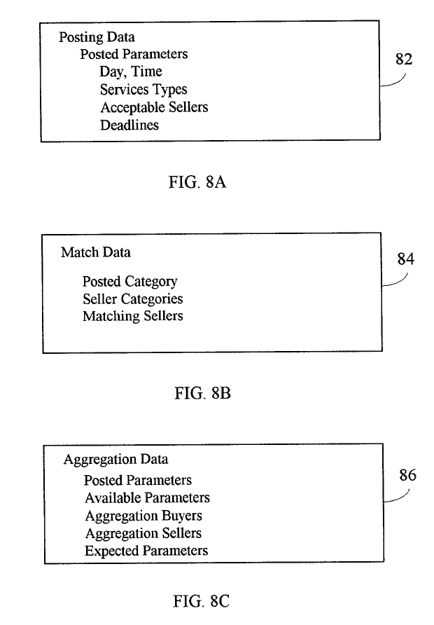

FIG. 8A depicts a buyer listing including a number of posted parameters. These parameters can include information such as the date and time that the service is needed, the duration or periodicity of the service and other parameters. FIG. 8B depicts match procedures for matching up the posted parameters with those that are listed from available providers. For example, a buyer may want to purchase computer network bandwidth for a specific duration such as a month or year, or a buyer may want to purchase computer processing based on cycles (e.g. floating point operations or FLOPS) or a specified duration or time. There may be additional parameters of interest that may be geographically related or otherwise related.

FIG. 8C depicts aggregation data that can be used to determine an aggregated market price for a given service. For example, if a number of buyers want to purchase computer network bandwidth between Los Angeles and New York, there may be a lower aggregated market price for the service and that could be passed along to the group of buyers.

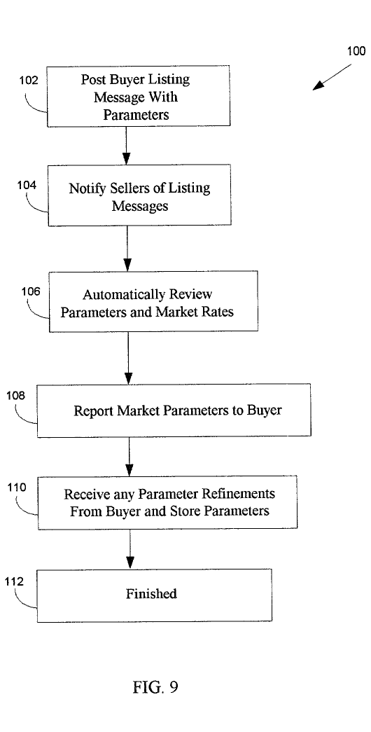

FIG. 9 is a flowchart 100 showing steps for adding a buy listing using automated matching. In step 102, the buyer posts an RFQ message with the buy parameters. In step 104, the system notifies sellers of the RFQ message. In step 106, the system automatically reviews the specified parameters and the market rates. Step 108 generates a market parameters report to the buyer with notification of the prevailing market rates for the service. In step 110, the buyer enters any parameter refinements and submits the RFQ message.

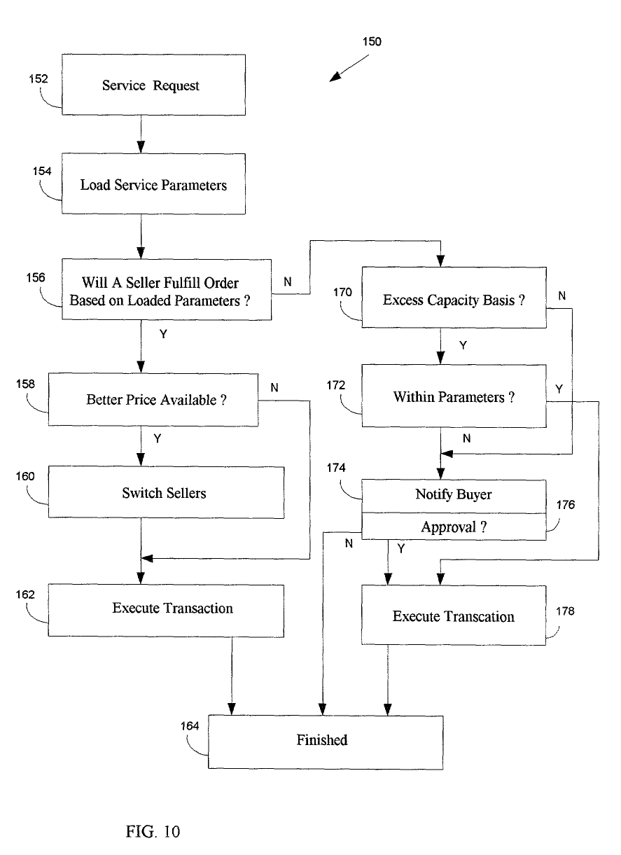

FIG. 10 is a flowchart 150 showing steps for fulfilling a service request. Step 152 is based on the flowchart 100 with the service request. In step 154, the final buyer parameters are entered into the system. Step 156 determines if based on those parameters, whether a seller will fulfill the service request. If yes, in step 158 the system checks to determine if there is a better price available. If there is a better price available, step 160 switches sellers to the one offering the better price. Step 160 will act only if the buyer parameters allow the switch to a different seller, and/or as long as the different seller is on an approved list. Step 162 executes the transaction and step 164 finishes.

If step 156 determines that no seller will fulfill the service request, then step 170 determines whether a provider will fulfill the request on an excess capacity basis. This may relevant if, for example, the request is to move a large amount of data that is not time sensitive. Step 172 determines is the service is within the specified parameters. If so, step 174 notifies the buyer and requests whether to proceed in step 176. If yes, step 178 executes the transaction. If no, then the transaction goes unfulfilled and step 164 finishes the procedure.

In another aspect of the invention, the exchange is dynamic and allows the buyer to specify a range over which the buyer is willing to buy the services. The transaction is processed based on the acceptable range; when the price is above the upper range limit, the transaction is not processed until the price falls below the upper range limit. In another aspect of the invention, the range can include a number of parameters such as time, day, price, acceptable sellers and others. This aspect if particularly useful for commodities where the price may vary by date or time, for example, computer network bandwidth or processing capacity may be less expensive at night.

In yet another aspect of the invention, the invention includes a contract manager that assists the buyer and seller in negotiating the services contract. This is similar to the aspect of the invention described above with reference to FIG. 6. Additionally, the escrow procedure as described above is available to assist the buyer and seller in creating and executing on a payment and deliverables plan. This is similar to the aspect of the invention described above with reference to FIGS. 6 and 7.

E. Conclusion

An advantage of the invention is the ability for the seller and buyer to negotiate a safe and secure transaction while minimizing risk to each party. Additional advantages include the ability of the service buyer to purchase the needed services at the best available market rate and to have the services delivered within the parameters identified by the buyer.

The invention has been described with reference to exemplary embodiments. Those skilled in the art will recognize that variations can be made to the description while remaining within the bounds of the claims.

1. A method of establishing a contract and exchanging payments between a buyer and seller comprising the steps of:
the buyer and seller agreeing on a contract specifying terms and conditions;
the buyer and seller agreeing on a multi-stage payment plan;
the buyer depositing a payment in an escrow account representing a first payment of the multi-stage payment plan;
the seller withdrawing from the escrow account the first payment of the multi-stage payment plan;
at a later time according to the multi-stage payment plan, the buyer depositing a payment in the escrow account representing a second payment of the multi-stage payment plan; and
the seller withdrawing from the escrow account the second payment of the multi-stage payment plan.

2. The method of claim 1, wherein:
the step of the buyer and seller agreeing on a contract specifying terms and conditions includes the step of the buyer and seller agreeing to a license for property.

3. The method of claim 1, further comprising the steps of:
the step of the buyer and seller agreeing on a contract specifying terms and conditions includes the step of the buyer and seller agreeing to a license for intellectual property.

4. A method of establishing a contract and exchanging services between a buyer and seller comprising the steps of:
a first party posting a message identifying one of a need and offer for a license;
a second party reviewing the message and responding to the message regarding the license;
the first party and second party agreeing on a payment plan and deliverable plan, wherein one party is the buyer of the license and the other party is the seller of the license;
the buyer depositing an amount of money in an escrow account, according to the agreed upon payment plan; and
the seller performing action or refraining from action as required by the license, and when the deliverable is approved by the buyer, receiving from the escrow account the amount of money equal to the agreed upon payment plan.

5. The method of claim 4, wherein:
the action required by the seller is that of refraining from enforcing a property right against the buyer as required by the license.

6. The method of claim 4, wherein:
the step of the first party and second party agreeing on a payment plan and deliverable plan includes the step of the first party and second party agreeing on a multi-stage payment plan and respective deliverable plan;
the step of the buyer depositing an amount of money in an escrow account is performed according to the agreed upon multi-stage payment plan; and
the step of the seller performing the service is performed according to the agreed upon deliverable plan.

7. The method of claim 6, wherein:
the step of the first party and second party agreeing on a payment plan and deliverable plan includes the step of the first party and second party agreeing on a multi-stage payment plan and a respective multi-stage deliverable plan; and
the step of the seller performing the service is performed according to the agreed upon multi-stage deliverable plan and includes the step of when respective deliverables are delivered to and approved by the buyer, receiving from the escrow account the amount of money equal to the respective stage of the agreed upon multi-stage payment plan.

8. The method of claim 7, wherein:
the buyer depositing step includes the buyer depositing an amount of money in an escrow account, where the amount of money at least meets the first stage of the multi-stage payment plan; and
the seller performing step includes the seller performing the first stage of the multi-stage deliverable plan, and when the first stage deliverables are delivered to and approved by the buyer, receiving from the escrow account the amount of money equal to the first stage of the multi-stage payment plan.

9. The method of claim 8, further comprising the step of:
the seller being paid an advance prior to the multi-stage payment plan.

10. The method of claim 8, wherein:
the buyer depositing step includes the step of the buyer depositing an amount of money in the escrow account, where the amount of money at least meets the first stage and second stage of the multi-stage payment plan; and
when the seller performing the first stage step is complete, the buyer depositing an additional amount of money in the escrow account, where the amount of money at least meets the third stage of the multi-stage payment plan.

11. The method of claim 10, further comprising the step of:
the seller being paid an advance prior to the multi-stage payment plan.

12. An apparatus for establishing a contract and facilitating the exchange of services between
a buyer and seller comprising:
a server including a memory configured to store a plurality of messages posted by first parties identifying one of a need and offer for services, wherein the server is accessible to second parties to review the messages and to respond to the messages and wherein one of the parties is the buyer and another of the parties is the seller;
a contract procedure configured to store a representations of contract terms agreed to between the buyer and seller, and wherein the memory is configured to store a message agreed to between the buyer and seller representing a payment plan and deliverable plan;
an escrow procedure configured to store a monetary representation of a deposit by the buyer equal to an amount of money in an escrow account, according to the agreed upon payment plan; and
wherein the escrow procedure includes a release procedure that is configured such that when the deliverable is delivered to and approved by the buyer, the release procedure releases from the escrow account the amount of money equal to the agreed upon payment plan.

13. The apparatus of claim 12, wherein:
the service is a license to use a specific property and the deliverable is the action of refraining from enforcing a property right against the buyer based on the contract.

14. The apparatus of claim 13, wherein:
the message agreed to between the buyer and seller is a multi-stage payment plan and respective deliverable plan.

15. The apparatus of claim 14, wherein:
the message agreed to between the buyer and seller is a multi-stage payment plan and respective multi-stage deliverable plan.

16. The apparatus of claim 15, wherein:
the escrow procedure is configured to accept the buyer depositing an amount of money in an escrow account, where the amount of money at least meets the first stage of the multi-stage payment plan; and
the release procedure is configured such that when the seller performs the first stage of the multi-stage deliverable plan, and when the first stage deliverable is delivered to and approved by the buyer, the release procedure releases from the escrow account the amount of money equal to the first stage of the multi-stage payment plan.

17. The apparatus of claim 16, wherein:
the escrow procedure includes the seller being paid an advance prior to the multi-stage payment plan.

18. The apparatus of claim 16, wherein:
the escrow procedure is configured to accept the buyer depositing an amount of money in an escrow account, where the amount of money at least meets the second stage of the multi-stage payment plan; and
the release procedure is configured such that when the seller performs the second stage of the multi-stage deliverable plan, and when the second stage deliverable is delivered to and approved by the buyer, the release procedure releases from the escrow account the amount of money equal to the second stage of the multi-stage payment plan.

19. The apparatus of claim 18, further comprising the step of:
the escrow procedure includes the seller being paid an advance prior to the multi-stage payment plan.
